(19) United States
(12) Patent Application Publication
(10) Pub. No.: US 2010/0073554 A1
(43) Pub. Date: Mar. 25, 2010

(54) Digital Image Acquiring And Transforming Apparatus

(76) Inventor: Paul Liu, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/272,789

(22) Filed: Nov. 18, 2008

(30) Foreign Application Priority Data
Sep. 23, 2008 (TW) 097217174

(51) Int. Cl. H04N 5/225

(52) U.S. Cl. 348/373; 348/207.99; 348/E05.024

(57) ABSTRACT

A digital image acquiring and transforming apparatus is provided. The digital image acquiring and transforming apparatus is adapted for acquiring and transforming images of stereoscopic and plane objects. The digital image acquiring and transforming apparatus includes a housing, a compensatory light source, an image acquiring unit and a rotatable plate. The housing is designed to have a semi-closed configuration. The rotatable plate is pivotally coupled to an unclosed end of the housing. Facilitated by the rotatable plate, the housing can achieve an entirely closed configuration. The image acquiring unit is disposed inside the housing and opposite to the rotatable plate. The compensatory light source is disposed inside the housing. The compensatory light source and the image acquiring unit, in combination, are adapted for effectively acquiring an image of an object disposed on the rotatable plate, and transforming the image into a digital file for saving.

### BACKGROUND OF THE INVENTION 1. Field of the Invention

The present invention relates generally to a digital image acquiring and transforming apparatus for acquiring and transforming images of stereoscopic and plane objects. Specifically, the digital image acquiring and transforming apparatus is adapted for acquiring plane images (e.g., photographs and pictures) and stereoscopic images, and transforming the acquired images into a digital file for saving.

2. The Prior Arts

Conventional optical cameras have been almost entirely substituted by digital cameras. Comparing with the digital cameras, a conventional optical camera records acquired images onto films (negatives), and thereafter displays the images in a form of photographs or slides to the viewers. Differing from the conventional optical camera, a typical digital camera transforms the acquired images into a digital file. The viewer can select to view the images by playing the digital file with an image player or develop the digital file to obtain photographs of the acquired images. Digital image files are incomparably convenient for recording and using relative to the conventional films and photographs. As such, the conventional films, photographs, and slides are now rarely used by modern people, so that it has become inconvenient to output images saved in the conventional approaches. However, the conventional optical cameras have been used for several decades after all, and there are many valuable conventional photographs accumulated and should be well protected and saved. Therefore, how to maintain and protect these accumulated photographs becomes a subject for many people.

Accordingly, many people select to duplicate the conventional photographs with a digital camera, and then transform the acquired images of the conventional photographs into a digital file for saving. This to some degree provides a solution for maintaining and protecting the conventional photographs. However, when desiring to achieve the optimal effect of the duplicated images which approach the original images as much as possible, these people may have to rely upon professionals to carry out the duplication. However, professionals often quote for an expensive cost for the duplication service, and such a professional service often consumes a long time.

Correspondingly, some manufactures have developed transforming apparatuses for directly transforming the conventional photographs into digital forms (e.g., a digital file). However, such a transforming apparatus is only capable of duplicating the photographs, and is incapable of acquiring images of external stereoscopic objects. As such, it is highly desired to develop a method or an apparatus adapted for both transforming conventional photographs into a digital image file and acquiring an external stereoscopic object. Having such an apparatus, a consumer is allowed to transform the conventional photographs into a digital image file by executing a simple process by himself without relying upon professionals. Therefore, such a method or apparatus provides a more convenient and simpler approach for those having conventional photographs and not having a digital file of the conventional photographs for image saving and protection.

### SUMMARY OF THE INVENTION

A primary objective of the present invention is to provide a digital image acquiring and transforming apparatus for acquiring and transforming images of stereoscopic and plane objects. The digital image acquiring and transforming apparatus is adapted for transforming conventional photographs into a digital file and also for acquiring an image of a stereoscopic object. By conveniently operating such an apparatus, one is allowed for transforming the conventional photographs into a digital file thus avoiding damages caused to the conventional photographs, without aids of professional staff or equipment.

The present invention provides a digital image acquiring and transforming apparatus for acquiring and transforming images of stereoscopic and plane objects. The digital image acquiring and transforming apparatus includes a housing, a compensatory light source, an image acquiring unit and a rotatable plate. The housing is designed to have a semi-closed configuration. The rotatable plate is pivotally coupled to an unclosed end of the housing. Facilitated by the rotatable plate, the housing can achieve an entirely closed configuration. The image acquiring unit is disposed inside the housing and opposite to the rotatable plate. The compensatory light source is disposed inside the housing. The compensatory light source and the image acquiring unit, in combination, are adapted for effectively acquiring an image of an object disposed on the rotatable plate, and transforming the image into a digital file for saving.

In comparison with the conventional optical cameras and other conventional technologies, the digital image acquiring and transforming apparatus according to the present invention has at least the following advantages:

(1) The digital image acquiring and transforming apparatus is adapted for transforming a photograph or a picture into a digital image file;

(2) The user can operate the digital image acquiring and transforming apparatus, instead of relying upon professionals, thus saving much time and expense; and

(3) The digital image acquiring and transforming apparatus is not only adapted for transforming plane objects (e.g., a photograph or a picture) into a digital image file, but also adapted for acquiring an image of a stereoscopic object and transforming the image into a digital image file.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a digital image acquiring and transforming apparatus according to an embodiment of the present invention;

FIG. 2 is a schematic view illustrating the digital image acquiring and transforming apparatus according to an embodiment of the present invention;

FIG. 3 is a schematic view illustrating the digital image acquiring and transforming apparatus according to an embodiment of the present invention;

FIG. 4 is a schematic view illustrating the digital image acquiring and transforming apparatus according to an embodiment of the present invention; and

FIG. 5 is a schematic view illustrating the digital image acquiring and transforming apparatus according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

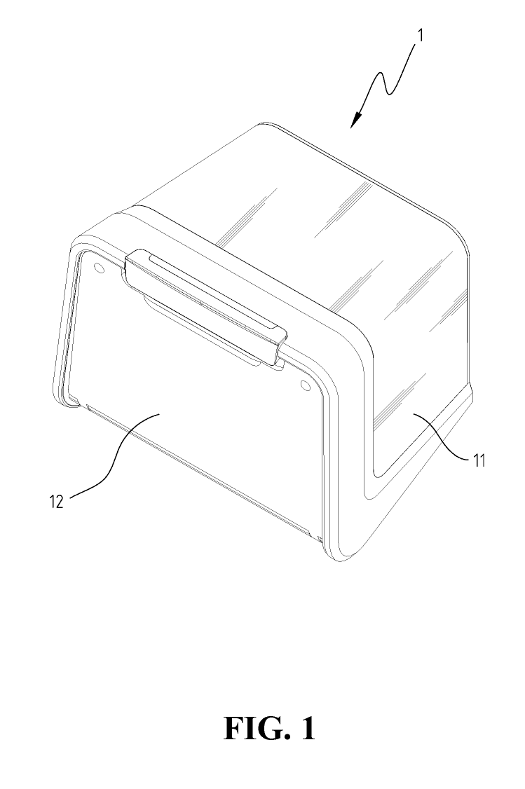

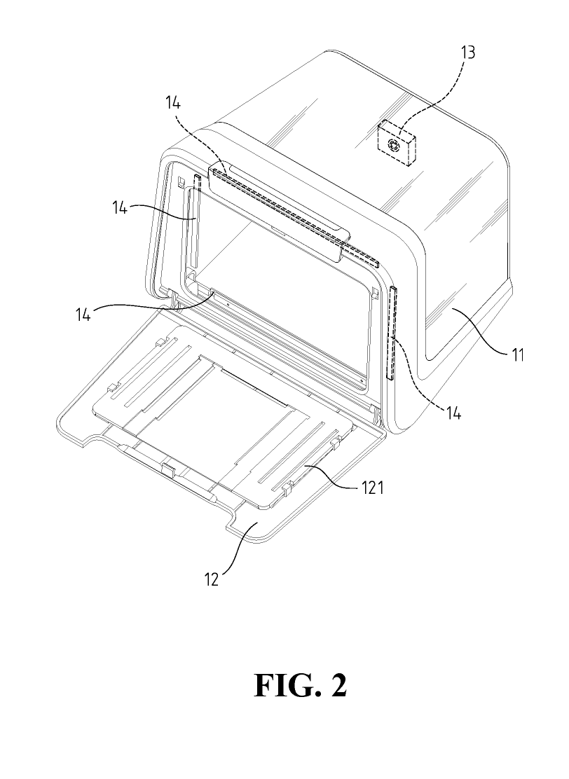

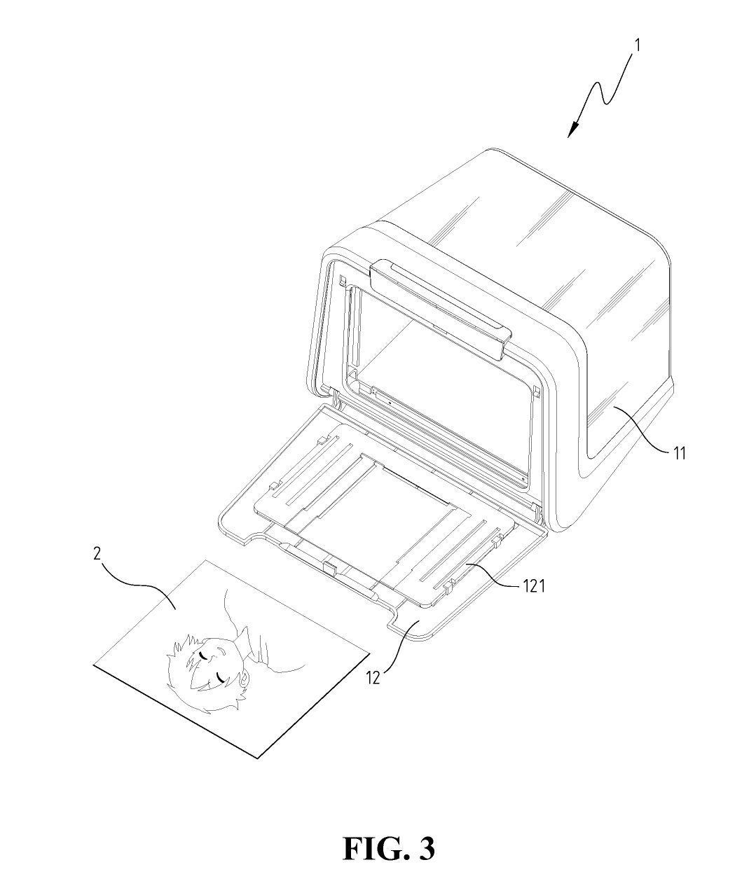

Referring to FIGS. 1, and 2, there is shown a digital image acquiring and transforming apparatus 1 according to an embodiment of the present invention. The digital image acquiring and transforming apparatus 1 includes a housing 11, a rotatable plate 12, an image acquiring unit 13, and a compensatory light source 14. The housing 11 is designed to have a semi-closed configuration having an opening configured at an opening end. The rotatable plate 12 is a plate member pivotally connected to the opening end of the housing 11. The rotatable plate 12 is adapted to cover the opening of the housing 11, so as to configure an entirely closed configuration together with the housing 11. The rotatable plate 11 is provided with a plate clip 121 at an edge of the rotatable plate 12. The plate clip 121 is adapted for fixing a plane carrier of an image to be acquired onto the rotatable plate 12, as shown in FIG. 3. The image acquiring unit 13 is equipped inside the housing 11 opposite and corresponding to the rotatable plate 12. The compensatory light source 14 is adaptively disposed inside the housing 11 at a suitable position. Preferably, the compensatory light source 14 includes four units disposed at four inner walls of the housing 11, respectively. Further, the units of the compensatory light source 14 are preferably strip-shaped LED lamps.

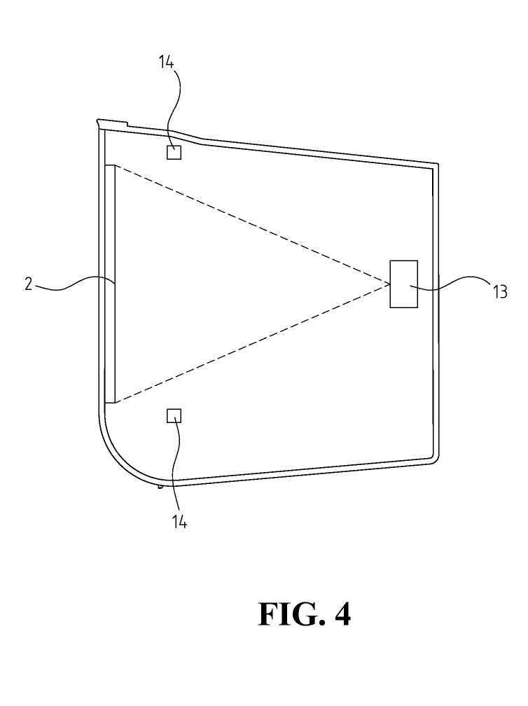

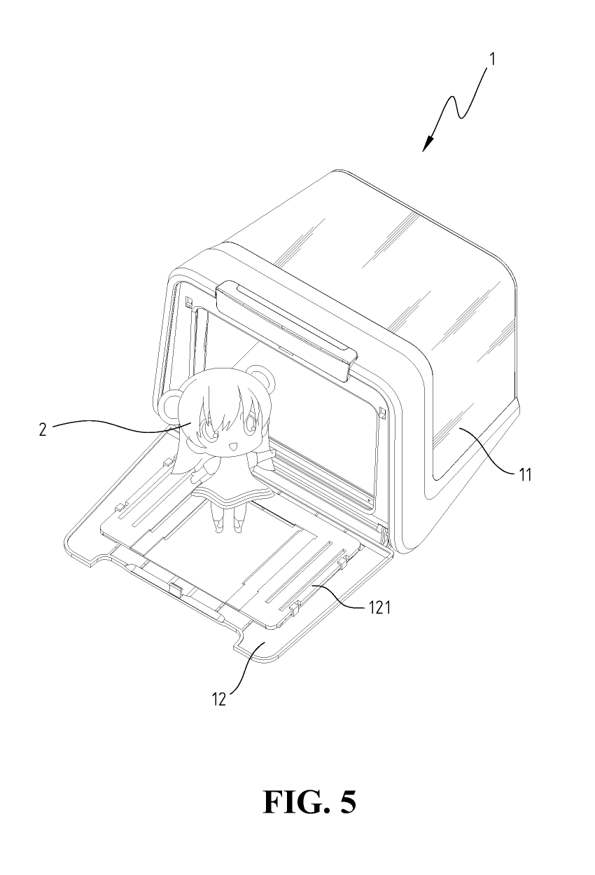

Referring to FIGS. 3, 4 and 5, the digital image acquiring and transforming apparatus 1 is adapted for acquiring and transforming images of stereoscopic and plane objects. In operation, when the digital image acquiring and transforming apparatus 1 is used for acquiring an image of a plane object (a picture or a photograph) 2 to be acquired, the plane object 2 is placed on the rotatable plate 12 and is fixed thereon by the plate clip 121. The rotatable plate 12 is then pivotally rotated to cover on the opening of the housing 11. In such a way, the plane object 2 fixed on the rotatable plate 12 is positioned at a predetermined position opposite to the image acquiring unit 13 for allowing the image acquiring unit 13 to acquire a digital image of the plane object 2. Alternatively, when the object which image is to be acquired is a stereoscopic object 2, the rotatable plate 12 is laid down and apart from the opening of the housing 11, and the stereoscopic object 2 is positioned on the rotatable plate 12, so as to allow the image acquiring unit 13 to acquire the image of the stereoscopic object 2. When the digital image acquiring and transforming apparatus 1 is used to acquire an image of a plane object or a stereoscopic object, the compensatory light source 14 can be used for providing necessary compensatory light for achieving an optimal imaging effect. After acquiring the image of the plane object or the stereoscopic object, the image acquiring unit 13 transforms the image into a digital file for saving. As such, the compensatory light source 14 and the image acquiring unit 13, in combination, are adapted for effectively acquiring an image of the object 2 disposed on the rotatable plate 12, and transforming the image into a digital file for saving.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A digital image acquiring and transforming apparatus, comprising:
a semi-closed housing configured with an opening at an opening end;
a rotatable plate, pivotally connected to the opening end of the semi-closed housing, wherein when the rotatable plate is closed to cover the opening, the semi-closed housing achieves an entirely closed configuration;
an image acquiring unit, disposed inside the semi-closed housing and opposite to the rotatable plate; and
a compensatory light source, adaptively disposed inside the semi-closed housing.

2. The digital image acquiring and transforming apparatus according to claim 1,
wherein the rotatable plate is further provided with a plate clip adapted for fixing a plane object onto the rotatable plate.

3. The digital image acquiring and transforming apparatus according to claim 1,
wherein the compensatory light source comprises four light source units.

4. The digital image acquiring and transforming apparatus according to claim 1,
wherein the compensatory light source is a strip-shaped LED lamp.
